(19) United States
(12) Patent Application Publication
(10) Pub. No.: US 2015/0259177 A1
(43) Pub. Date: Sep. 17, 2015

(54) Passenger Conveyor Systems with Separate Chain and Pallet Tracks

(71) Applicants: Walter Srb-Gaffron, Baden (AU); Alexander Turek, Vienna (AU)

(72) Inventors: Walter Srb-Gaffron, Baden (AU); Alexander Turek, Vienna (AU)

(21) Appl. No.: 14/434,449

(22) PCT Filed: Nov. 1, 2012
(86) PCT No.: PCT/US2012/063052

§ 371 Date: Apr. 9, 2015

(51) Int. Cl. B66B 23/14; B66B 21/12

(52) U.S. Cl. CPC B66B 23/147; B66B 21/12

(57) ABSTRACT

A passenger conveyor with reduced pallet travel height is disclosed. The moving walkway generally includes a chain track and a pallet track separate from the chain track, a drive chain movably disposed in the chain track, and a plurality of pallets coupled to the pallet track. Each of the pallets may be movably connected to the drive chain and the drive chain may travel at a different velocity than the plurality of pallets in a portion of the passenger conveyor. Methods for reducing distance between passenger and return portions of an endless series of pallets are also disclosed.

### TECHNICAL FIELD OF THE DISCLOSURE

The present disclosure is generally directed to passenger conveyor systems, and more particularly, to passenger conveyor systems with separate chain and pallet tracks.

### BACKGROUND OF THE DISCLOSURE

A variety of passenger conveyor systems such as, moving walkways, escalators, etc. are commonly used to transport people from pone point to another. Moving walkways are typically constructed in one of two basic styles, either pallet type or moving belt type. A moving belt type moving walkway typically includes a metal mesh or rubber belt disposed over a series of rollers. A pallet type moving walkway typically includes a continuous series of pallets joined together to form a walkway.

Pallet-type moving walkways generally include a truss assembly, which houses a drive mechanism that drives the pallets. Specifically, the pallets are fixed to a drive chain that includes a plurality of interconnected rollers. The drive chain is engaged with a chain track and is operatively connected to the drive mechanism, such as one or more drive sprockets. As the drive mechanism drives the drive chain, the pallets moves along the chain track from a passenger carrying side to a return side, which is typically located below the passenger carrying side. The walkway assembly including the truss assembly, drive mechanism and the return side of the walkway is typically located in a pit constructed for that purpose.

In moving walkways with pit construction, the height difference between the surrounding floor level and the passenger carrying portion of the pallets (i.e. pallet height) may sometimes require relatively steep and/or lengthy ramps at the ends of the moving walkway for passenger comfort and handicapped access. In addition, parallel moving walkways, operating in opposite directions, would require two pits, two drive mechanisms and two pallet bands, thereby further adding expense and space requirements for installation of the moving walkways.

Thus, there is a need for a moving walkway that may not need a pit in the floor and therefore may be mounted either on finished, existing floors or in foreseen openings of floating screed but doesn't have any impact on the structure of floors (concrete ceilings, beams, etc.). Moreover, there is a need for a moving walkway with reduced passenger carrying surface height for passenger comfort, handicapped access, and/or the aesthetics of the landing design. Finally, there is a need for a pit-free moving walkway with reduced pallet height while maintaining the functionality, simplicity, and reliability of its components.

### SUMMARY OF THE DISCLOSURE

In accordance with one aspect of the present disclosure, a passenger conveyor is disclosed. The passenger conveyor may include a chain track and a pallet track separate from the chain track, a drive chain movably disposed in the chain track, and a plurality of pallets coupled to the pallet track. Each pallet may be movably connected to the drive chain and, as a result of the separate pallet and chain tracks and the connection arrangement between the pallets and the drive chain, the pallets may travel a different path and may have a different velocity relative to the drive chain in portions of the path.

In accordance with another aspect of the present disclosure, a method for reducing distance between passenger portion and return portion of an endless series of pallets is disclosed. The method may generally include the steps of allowing the pallets to by guided by a pallet track, allowing a drive chain to be guided by a chain track that is separated from the pallet track, each pallet being movably connected to the drive chain, and driving the drive chain to move the pallets along the pallet track.

In accordance with yet another aspect of the present disclosure, a moving walkway is disclosed. The moving walkway may include a plurality of pallets coupled to and guided by a pallet track, a drive chain disposed in and guided by a chain track, the chain track horizontally offset from the pallet track, and a leg movably connecting each of the plurality of pallets to the drive chain. As a result of the offset pallet and chain tracks and the connection arrangement between the pallets and drive chain, the pallets may travel a different path and may have a different velocity relative to the drive chain in portions of the path

The passenger conveyor may include one or more of the following features, either alone or in combination:

the pallet track and chain tracks are vertically offset from each other;

the pallet track and chain tracks are horizontally offset from each other;

the pallet tracks and chain tracks are arranged in a digressive configuration;

the pallet tracks and chain tracks are arranged in a progressive configuration;

the chain tracks are longitudinally offset from each other;

the pallets and chains are connected via one or more pivot points;
the pallets and chains are connected via one or more legs and the legs are connected to the front and/or rear of the pallet; and
the pallets and chains are connected via one or more legs and the legs are connected to a longitudinal mid-portion of the pallet;

Other advantages and features of the disclosed apparatus and method will be described in greater detail below. It will also be noted here and elsewhere that the apparatus or method disclosed herein may be suitably modified to be used in a wide variety of applications by one of ordinary skill in the art without undue experimentation.

### BRIEF DESCRIPTION OF THE DRAWINGS

For a more complete understanding of the disclosed apparatus and method, reference should be made to the embodiments illustrated in greater detail in the accompanying drawings, wherein:

FIG. 1 schematically illustrates one prior art moving walkway with a classical pallet turning design;

FIG. 2 schematically illustrates another prior art moving walkway with a Paternoster pallet turning design;

FIG. 3 is a schematic perspective view of a degressive track separation system employed within a moving walkway according to at least some embodiments of the present disclosure;

FIG. 4A is a schematic illustration of another embodiment of the degressive track separation system of FIG. 3;

FIG. 4B is a schematic illustration of a further embodiment of a degressive track separation system;

FIG. 5 is a schematic top view of a progressive track separation system employed within a moving walkway according to at least some other embodiments of the present disclosure; and

FIG. 6 is a flow chart of a method for reducing distance between a passenger portion and a return portion of an endless series of pallets.

It should be understood that the drawings are not necessarily to scale and that the disclosed embodiments are sometimes illustrated diagrammatically and in partial views. In certain instances, details which are not necessary for an understanding of the disclosed device or method which render other details difficult to perceive may have been omitted. It should be understood, of course, that this disclosure is not limited to the particular embodiments illustrated herein.

### DETAILED DESCRIPTION OF THE DISCLOSURE

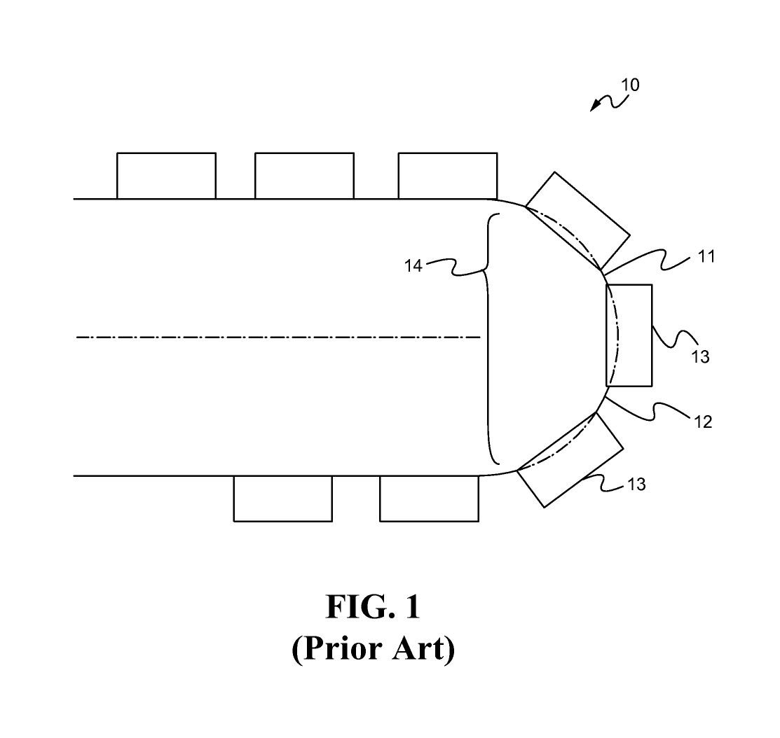

Referring now to FIG. 1, a schematic representation of a conventional moving walkway 10 (classical design) illustrating pallet motion therein is shown. As shown, the moving walkway 10 may include a drive chain 11 movably disposed within a chain (or pallet) track 12. The moving walkway 10 further includes a plurality of pallets 13 fixedly connected to the drive chain 11. In use, the drive chain 11 is operated by a drive mechanism (not shown), such as a drive sprocket, to move within the chain track 12. As the pallets 13 are fixedly connected to the drive chain 11 and therefore have zero degree of freedom relative to the drive chain 11, the pallets follow the chain track 12 and turn up-side-down at an end portion 14 of the moving walkway 10. One feature of the classical design is that the pallets 13 move at the same velocity and follow the same path as the driven chain 11 at any portion of the moving walkway 10.

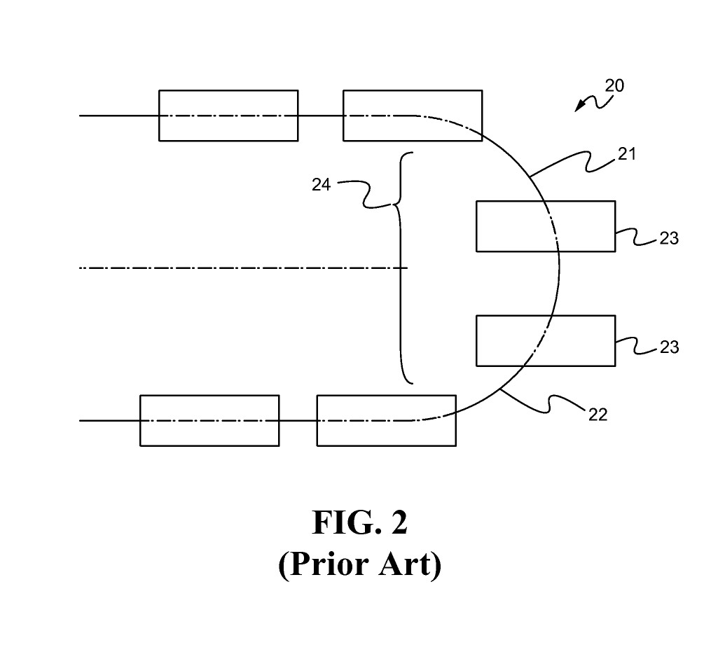

Turning to FIG. 2, another conventional moving walkway 20 (Paternoster design) showing pallet motion therein is illustrated as generally including a drive chain 21 movably disposed within a chain (or pallet) track 22. The moving walkway 20 further includes a plurality of pallets 23 directly hinged to drive chain 21. In use, the drive chain 21 is operated by a drive mechanism (not shown) to move within the chain track 22. As the pallets 23 are directly hinged to the drive chain 21 with one degree of freedom, the pallets 23 follow the chain track 22 but rotate relative to the drive chain to maintain its horizontal orientation at an end portion 24 of the moving walkway 20. Similar to the classical design, a feature of the Paternoster design is that the pallets 23 move at the same velocity and follow the same path as the driven chain 21 at any portion of the moving walkway 20.

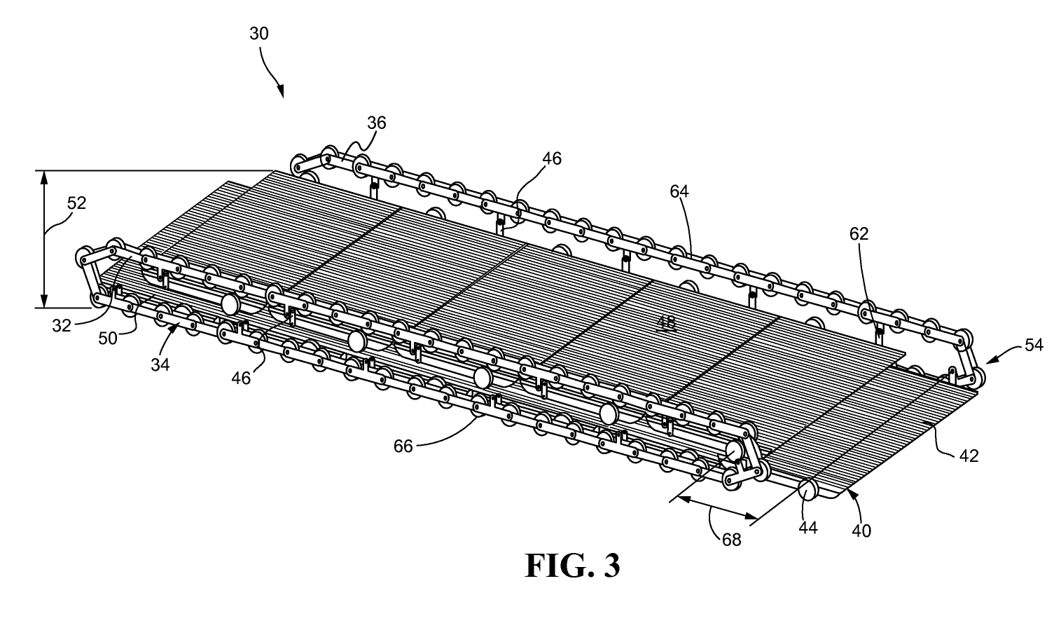

Referring now to FIG. 3, a first embodiment of a moving walkway 30 is shown, in accordance with at least some embodiments of the present disclosure. As shown, the moving walkway 30 may include a chain track 32 and a drive chain 34 movably disposed in the chain track. The drive chain 34 may include a plurality of interconnected links 36, at least some of which may be provided with rollers 38 disposed in the chain track 32 to facilitate movement of the drive chain along the chain track. The moving walkway 30 may additionally include a pallet track 40 having a plurality of pallets 42. In at least some embodiments and, as shown in FIG. 3, the chain tracks 32 on either side of the walkway 30 may be longitudinally offset from each other. In addition, for the configuration shown in FIG. 3, the pallet tracks 40 and the chain tracks 32 on each side of the walkway 30 may also be longitudinally offset from each other.

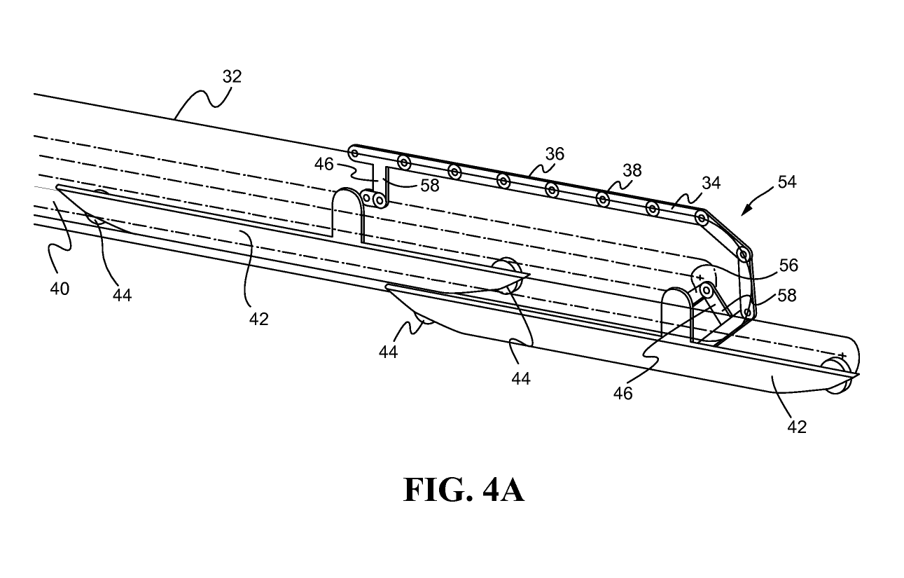

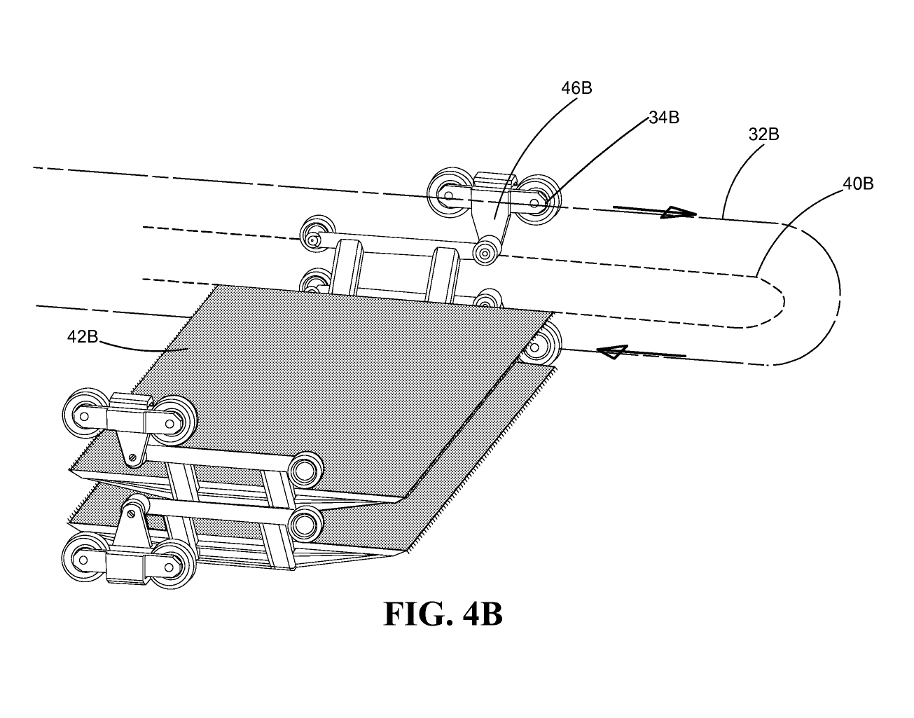

Each of the plurality of pallets 42 may be provided with rollers 44 disposed in the pallet track 40 so that the pallets may be coupled to and be guided by the pallet track. In addition, each of the plurality of pallets 42 may be movably (e.g., pivotably) connected to the drive chain 34. Specifically and as shown, at least some of the interconnected links 36 of the drive chain 34 may include legs (e.g., levers) 46 configured to be pivotably connected to the pallets 42 and the drive chain 34 such that the pallets can have at least one degree of freedom (i.e. rotation) relative to the drive chain. The manner of linkage between the drive chain 34 and the pallets 42 may vary depending upon the space and height requirements of the moving walkway 30. For example, in at least some embodiments, the legs 46 may be fixed to link plates of the interconnected links 36 of the drive chain 34 and may pivot at a point where it connects to the pallets 42, resulting in a very short distance between the pallets on a passenger side 48 and a return side 50, thereby allowing to reduce a pallet height 52 (distance between the floor and the pallet track on the passenger side 2) of the pallet track 40. In other embodiments, the legs 46 may be fixed at the pallet joint and may pivot at the joint of the interconnected links 36 of the drive chain 34. In yet other embodiments and as described below in FIG. 4A, the legs 46 may be provided with multiple pivoting points.

It will also be understood that the location of the legs 46 with respect to the length of the pallets 42, as well as the location and number of the rollers 44 on the pallets may vary. For example, as shown in FIG. 3, each of the pallets 42 may be provided with one of the rollers 44 and one of the legs 46 towards each end portion of the pallets in a staggered arrangement or, as shown in FIG. 4A, with the legs 46 provided midway between pairs of rollers 44 on each end of the pallet. In addition, other arrangements of the legs and rollers are possible, such as two legs on one end and two rollers on the opposite end (not shown).

Furthermore, unlike the classical and Paternoster designs of FIGS. 1 and 2, respectively, the pallet track 40 and the chain track 32 of the moving walkway 30 may be separated or otherwise offset from one another. In at least some embodiments and, as shown in FIG. 3, the chain track 32 and the pallet track 40 may be vertically offset from each other, on both the passenger side 48 (e.g., the side on which the passengers ride) and the return side 50. The track separation between the pallet track 4o and the chain track 32 is showed by reference numeral 62 in FIG. 3. In other words, as viewed from the side or top, the pallet track 40 may lie within the chain track 32 with the passenger side 48 of the pallet track above the return side 50 thereof (i.e., the pallets on the return side of the pallet track 40 can be positioned vertically higher than the chain track 32 on the return side) to reduce a pallet gap (PG) between the pallets 42 on the passenger side and the return side.

Such an arrangement of the chain track 32 and the pallet track 40 may be referred to as a degressive track separation system in that by positioning the pallet track 40 within the chain track 32, the pallets may travel at a slower velocity than the associated chain links at a turnaround portion 54 of the chain track 32 as the pallets 42 transition from the passenger side 48 to the return side 50. This arrangement may further reduce the pallet height 52 (in conjunction with the pivotable connection between the drive chain 34 and the pallets 42 described above) as compared to conventional walkways of FIGS. 1 and 2. Further, the length of the pallet track may be shortened as compared to conventional walkways such as FIGS. 1 and 2.

FIG. 3 also shows a configuration of the moving walkway 30 in which the drive chain 34 and the chain track 32 on opposite sides of the walkway 30 are longitudinally offset from each other. For example and as shown in FIG. 3, the chain track 34 may include a first chain track 64 and a second chain track 66 that may be offset indicated by reference numeral 68. The off-set 68 may be the result of having the pallets 42 with staggered legs 46 on each side, i.e., the connections between the pallets and the chains 34 is on opposite ends of each pallet on opposing sides. Due to the longitudinal offset of the left and the right chain strand at the return and the diagonally located pivoting point on which the pallets 42 are coupled to the drive chain 34, the pallet does not need additional guidance in the return portion when the drive chain itself is turned by the chain track 32 and/or sprocket. Each of the pallets 42 can turn around in a stable manner similar to the paternoster type return of FIG. 2 and when combined with the vertically digressive track separation, results in a significantly reduced space requirement.

Referring now to FIG. 4A, another one of the moving walkway 30 with a vertical track separation system is shown, in accordance with at least some embodiments of the present disclosure. Similar to the moving walkway 30 of FIG. 3, the moving walkway of FIG. 4A may include the chain track 32 and the pallet track 40 vertically offset from the chain track. However, in contrast to the moving walkway 30 of FIG. 3, which has one roller 44 on each end of the pallets 42, in the moving walkway 30 of FIG. 4A, each of the pallets includes two of the rollers 44 at each end. Specifically, each of the pallets 42 includes a pair of front rollers and a pair of rear rollers and the legs 46 are provided at the same longitudinal position on each side of the pallet in between the front and rear rollers along the length of the pallets 42. Furthermore, the legs 46 include a pivotable lever 56 that is attached to a leg 58 fixed on the drive chain 34 thus providing a pivoting connection on both the pallet and the chain link. The positioning of the legs on opposite sides but at the same longitudinal position would result in a chain track having no off-set, similar to a more conventional chain track arrangement.

It will be understood that while FIG. 3 has been described with one type of pivotal linkage between the drive chain 34 and the pallets 42, and FIG. 4 has been described with another type of pivotal linkage, in at least some embodiments, the pivotal linkage of FIG. 4A may be used with the moving walkway of FIG. 3 and vice-versa and in addition the pivoting linkage may be provided at any position along the pallet. Furthermore, the number of the rollers 44 may vary from that shown in both FIGS. 3 and 4A.

A further embodiment of the moving walkway 30 is shown schematically in FIG. 4B. This configuration includes pallets 42B that move along a pallet track 40B, a pair of drive chains 34B that move along a chain track 32B, and a pivoting connection via lever 46B between the drive chains 34B and the pallets 42B. As with the configuration of FIG. 3, the connections between the drive chains 34B and the pallets 42B is staggered such that the drive chain tracks 32B may be longitudinally offset from each other. It should be noted that, although not shown in the figures, the drives for each of the drive chains 34 (or 34B), such as a sprocket or other type of driving device, may also need to be longitudinally offset in order to engage each drive chain.

Due to the relative turning to each other (180°) in every return, the pallet track 40B may remain very flat, thereby making it possible to reduce the space from floor up to the thread surface (passenger line) of the pallets 42B. When the vertical height is reduced in this manner, the pallets 42B may also need to be stackable to avoid collisions and to manage the return of the pallets in the very limited space under the passenger line pallets, i.e., the pallets may need to be formed to fit within each other to avoid interference during longitudinal motion.

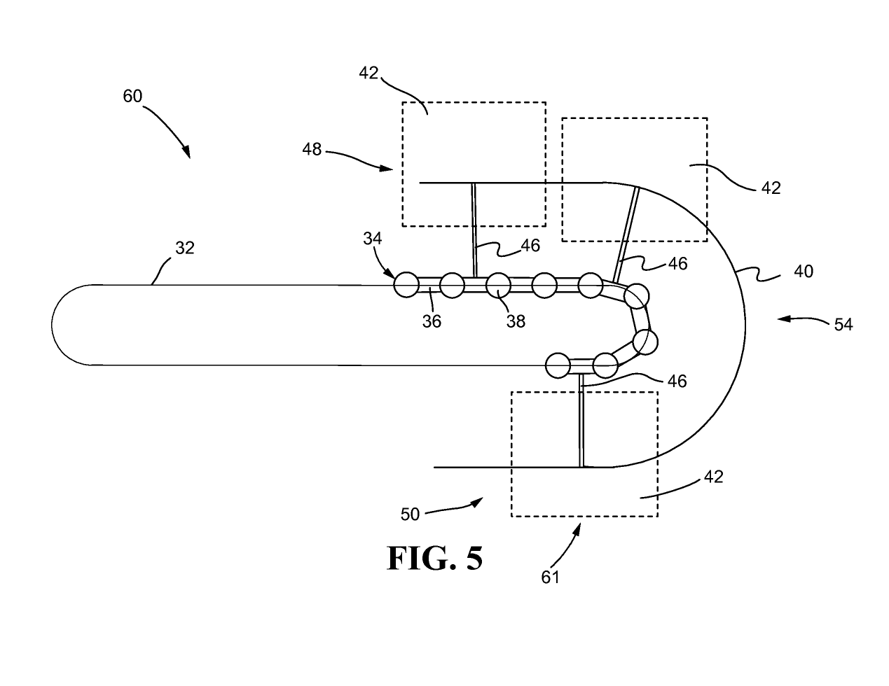

Turning now to FIG. 5, a schematic illustration of a moving walkway 60 is shown, in accordance with at least some embodiments of the present disclosure. The moving walkway 60 is substantially similar to the moving walkway 30 but includes two passenger portions 61 side by side and moving in opposite directions (each passenger portion serves as the return track for the other passenger portion). Specifically, similar to the moving walkway 30, the moving walkway 60 may include the chain track 32 for driving the drive chain 34 and the pallet track 40 for driving the plurality of pallets 42. The pallets 42 may be connected to the drive chain 34 via the legs 46. The pivotal linkage of the legs 46 may be any of those described above.

In contrast to FIGS. 3 and 4A-B, which describe a degressive track separation system, the moving walkway 60 describes a progressive track separation system in that by positioning the pallet track 40 outwardly of the chain track 32, the pallets may travel at a faster velocity than the associated chain links at the turnaround portion 54 of the chain track 32. As shown in FIG. 5, in a progressive track separation system, the chain track 32 may be horizontally offset from the pallet track 40, i.e., when viewed from the top, the chain track may lie within the pallet track (e.g., the width of pallet track from the passenger side 48 to the return side 50 may be greater than that of the chain track). Specifically, the chain track 32 may be provided on the sides of the pallet track 40 to conserve space below the pallet track and facilitate a pit-free design.

In yet other embodiments, the chain track and the pallet track 32 and 40, respectively, may be offset or otherwise separated from one another in other directions as well, such as a combination of horizontal and vertical separation. By virtue of separating the chain track 32 from the pallet track 40 (either vertically, horizontally, or a combination thereof) and the movable connection between the drive chain and the pallets, each of the plurality of pallets 42 may move at different velocities (speed and/or direction) than the associated chain links in some portions of the moving walkway 30, in particular in the return portion. The use of pivoting legs increases the variability of the differential movement between the pallet and chain tracks. As a result, the moving walkway can be optimized for compactness, both in pit depth and longitudinal length of the tracks by having the pallet tracks internal to the chain tracks (degressive), or for layout benefits by having the pallet tracks external to the chain tracks (progressive), or hybrid arrangements with the projections of the chain and pallet tracks overlapping each other.

Additionally, the pivotable connections described above are merely three embodiments of the movable connections between the drive chain 34 and the pallets 42. Other coupling mechanisms that enable one or more degree of freedom between the drive chain 34 and the pallets 42 may also be employed. For example, the pallets 42 may be coupled to the drive chain 34 through a geared connector or other form of flexible connector so that the pallets can have rotational and/or translational movement relative to the drive chain.

Thus, by virtue of separating the chain track 32 from the pallet track 40 and by pivotably connecting those tracks together, the depth of the pallet track may be independent of the chain track, thereby providing a shallower path for the pallets 42 within the moving walkways 30, 60. Furthermore, the movable connection between the drive chain 34 and the pallets 42 allows travel at different velocities at their corresponding turnaround portions. The chain track 32 may also be conveniently disposed within the balustrade or other adjacent structure by virtue of separating the chain track from the pallet track 40.

### INDUSTRIAL APPLICABILITY

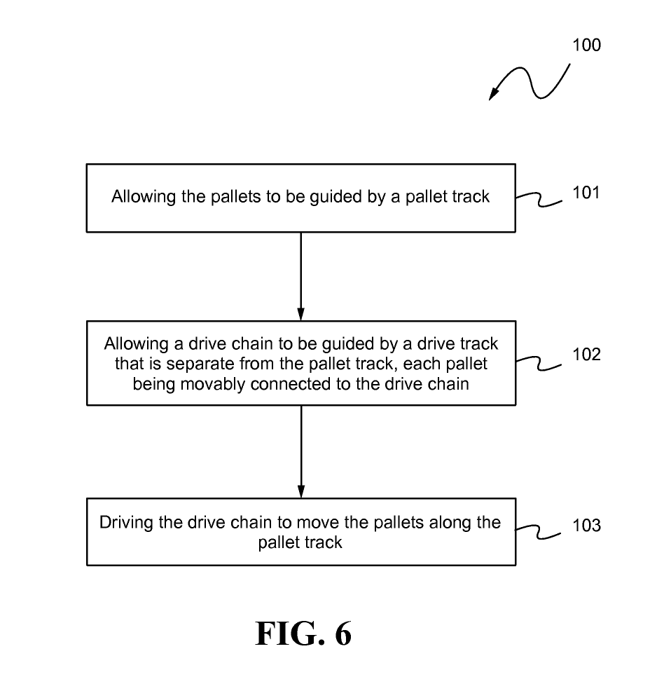

The separation of chain and the pallet tracks disclosed herein may have a wide range of applications in design, installation and operation of moving walkways. As illustrated in FIG. 6, a method for reducing a distance between passenger portion and return portion of an endless series of pallets is generally referred to as reference numeral 100. The method 100 may generally include the steps of allowing the pallets to by guided by a pallet track 101, allowing a drive chain to be guided by a chain track that is separate from the pallet track and to which each pallet is movably connected 102, and driving the drive chain to move the pallets along the pallet track.

As discussed earlier, the separation of the pallet track from the chain track allows the drive chain and pallets to travel at different velocities at their corresponding turnaround portions of the drive and pallet tracks, thereby reducing the pallet height (PH) of the moving walkway as compared to conventional moving walkways. The reduced pallet height may allow, by itself or in combination with other structural features, a pit-free moving walkway unavailable to conventional moving walkways.

Furthermore, by separating the chain track and the pallet track, a relatively wide chain track distance may be achieved and the pivotable connection between the chain track and the pallet track may provide a smooth movement and acceleration in a relatively simple turnaround, while reducing the pallet height of the entire pallet band. In addition, the pallets may be turned around from the passenger side to the return side in a paternoster fashion, thereby diminishing collision areas between pallets.

It will be understood that while the disclosure above has been described in relation to a moving walkway, the invention is applicable to other types of passenger conveyors, such as escalators and other types of moving walkways, and as used herein the general terminology of pallets, pallet chains and pallet tracks also encompasses steps, step chains and step tracks as used in escalators.

While only certain embodiments have been set forth, alternative embodiments and various modifications will be apparent from the above descriptions to those skilled in the art. These and other alternatives are considered equivalents and within the spirit and scope of this disclosure.

1. A passenger conveyor, comprising:
a chain track and a pallet track separated from the chain track;
a drive chain movably disposed in the chain track; and
a plurality of pallets coupled to the pallet track, each of the plurality of pallets being movably connected to and guided by the drive chain, the plurality of pallets moving at a velocity different than the velocity of the drive chain in a portion of the passenger conveyor.

2. The passenger conveyor of claim 1, wherein the pallet track is vertically offset from the chain track.

3. The passenger conveyor of claim 2, wherein by vertically offsetting the pallet track from the chain track, a pallet gap between a passenger side and a return site of the plurality of pallets is reduced.

4. The passenger conveyor of claim 2, wherein by vertically offsetting the pallet track from the chain track, the plurality of pallets travel at a slower velocity than the drive chain at a turnaround portion resulting in a relatively narrow pallet track return.

5. The passenger conveyor of claim 2, wherein by vertically offsetting the pallet track from the chain track, the pallet track lies within the chain track.

6. The passenger conveyor of claim 1, wherein the pallet track is horizontally offset from the chain track.

7. The passenger conveyor of claim 6, wherein by horizontally offsetting the pallet track from the chain track, the pallet track lies outside of the chain track.

8. The passenger conveyor of claim 6, wherein by horizontally offsetting the pallet track from the chain track, the plurality of pallets travels at a faster velocity than the drive chain.

9. The passenger conveyor of claim 1, wherein the chain track includes a first chain track and a second chain track, and wherein the first and second chain tracks are longitudinally offset from each other.

10. The passenger conveyor of claim 1, wherein the pallet track extends longitudinally further than the chain track.

11. The passenger conveyor of claim 1, wherein each of the plurality of pallets is movably connected to the drive chain through a leg.

12. The passenger conveyor of claim 11, wherein the leg provides one point of pivoting to the plurality of pallets with respect to the drive chain.

13. The passenger conveyor of claim 11, wherein the leg provides multiple points of pivoting to the plurality of pallets with respect to the drive chain.

14. The passenger conveyor of claim 1, wherein by separating the chain track from the pallet track, the depth of the pallet track is independent of the depth of the chain track.

15. A method for reducing a vertical distance between a passenger portion and a return portion of an endless series of pallets, the method comprising:
allowing the pallets to be guided by a pallet track;
allowing a drive chain to be guided by a chain track that is separated from the pallet track, each pallet being movably connected to the drive chain; and
driving the drive chain to move the pallets along the pallet track.

16. The method of claim 15, wherein the chain track includes a first chain track and a second chain track, and wherein the first and second chain tracks are longitudinally offset from each other.

17. The method of claim 15, wherein the pallet track extends longitudinally further than the chain track.

18. The method of claim 15, wherein driving the drive chain to move the pallets along the pallet track comprises providing a leg movably connecting each of the pallets to the drive chain in a substantially central portion of the pallets.

19. The method of claim 15, wherein driving the drive chain to move the pallets along the pallet track comprises providing a leg movably connecting each of the pallets to the drive chain in an end portion of the pallets.

20. The method of claim 19, further including a second leg, wherein the first leg is connected to a forward portion of the pallet and the second leg is connected to a rear portion of the pallet on the opposite lateral side.

21. A moving walkway, comprising:
a plurality of pallets coupled to and guided by a pallet track;
a drive chain disposed in and guided by a chain track, the chain track horizontally offset from the pallet track and the drive chain travelling at a slower velocity than the plurality of pallets in a portion of the moving walkway; and
a leg movably connecting each of the plurality of pallets to the drive chain.

22. The moving walkway of claim 21, wherein the pallet track extends longitudinally further than the chain track.

23. The moving walkway of claim 21, wherein the chain track includes a first chain track and a second chain track, and wherein the first and second chain tracks are longitudinally offset from each other.

24. The moving walkway of claim 21, wherein the chain track and the pallet track are arranged in a degressive configuration.

25. The moving walkway of claim 21, wherein the chain track and the pallet track are arranged in a progressive configuration.
